(19) United States
(12) Patent Application Publication
(10) Pub. No.: US 2017/0145739 A1
(43) Pub. Date: May 25, 2017

(54) Integrated Shade System as a Window Covering

(71) Applicant: Red Forest Tech, LLC, Foothill Ranch, CA (US)

(72) Inventors: Won J. Choi, Foothill Ranch, CA (US); Evgeny Trufkin, Foothill Ranch, CA (US)

(73) Assignee: Red Forest Tech, LLC, Foothill Ranch, CA (US)

(21) Appl. No.: 15/018,071

(22) Filed: Feb. 8, 2016

Related U.S. Application Data
(60) Provisional application No. 62/258,288, filed on Nov. 20, 2015.

(51) Int. Cl. E06B 9/264; B60J 1/20; B63B 17/02; E06B 9/32; E06B 9/42; B60J 1/16; B62D 25/04; E06B 9/262

(52) U.S. Cl. CPC E06B 9/264; B62D 25/04; B60J 1/2013; E06B 9/262; E06B 9/32; E06B 9/42; B60J 1/16; B63B 17/02; E06B 2009/2625; E06B 2009/2622

(57) ABSTRACT

A shade system that is designed to shield at least part of a space from light and be embedded into a stable structure or frame, comprises: a top fixture, a bottom fixture, an attachment component, wherein the attachment component is held in place by the top fixture and the bottom fixture, and a flexible light or sun shield component, wherein the shield component is retractably attached to the attachment component. It should be understood that a contemplated shade system is designed to shield the interior of a car, boat, vehicle or space from sunlight, street light or bright light to a fixture, such as a neon sign. Methods of securing and using contemplated shade systems are also disclosed.

This United States Utility Application claims priority to U.S. Provisional Application Ser. No. 62/258,288 entitled “Integrated Shade System as a Window Covering” filed on Nov. 20, 2015, which is commonly-owned and incorporated herein in its entirety by reference.

### FIELD OF THE SUBJECT MATTER

The field of the subject matter is integrated or built-in shades as a window covering, including windows in cars, trucks, boats, mobile homes and recreational vehicles, and prefabricated homes.

### BACKGROUND

An entire industry has been developed to try and keep the sun out of a vehicle, boat, mobile home or other spaces that are small and can heat up quickly without protection. In addition, many of the surfaces in these small spaces become washed out or sun-bleached over time, if the space is not protected by a suitable sun blocker.

Several iterations of sun blockers and sun shades have been developed over the years, and while a number of these are functional to keep a majority of the sun out of a space, they are either hard to use, temporary in their functionality or ill-suited for the particular space. For example, there are portable sun shades that are usually folded up and stored away in the trunk, back seat or glove compartment of a vehicle. They have to be retrieved, unfolded, and placed in the windshield each time they are used—and they often don't fit well, because they aren't anchored or secured to the window. In some prior art embodiments, the designers tried to fix the problem by using suction cups on the corners of the sun shade, in order to secure the sun shade to a window or windshield. However, this design often fails after a short period of time, because the suction cups heat up and separate from the glass.

U.S. Pat. No. 4,929,014 discloses a full windshield sunshade that is built in to the roof of a car and is pulled down by the driver or passenger to cover the front windshield. While this is an attempt to solve some of the problems of the prior art models, it suffers from the ability of it to adapt to modern cars. For example, the sun shade is retractable into the roof of the car, where there are guides built into the roof that direct the shade as it is extended and then retracted. These guides are fixed and resemble railroad tracks. Many cars now come with a standard or extended sunroof that does not allow for the necessary tracks to be secured at or in the roof of the car.

WO 20150180012 is based on a Chinese patent application where the inventors describe an embedded cloth sun shade system, wherein the shade is embedded into the bottom or “rear” of the front or back windshield. This design modification appears to address some of the problems of U.S. Pat. No. 4,929,014, but there are additional problems that are presented with this design. First, it is difficult for most people to reach over the steering wheel and all the way to the bottom of the windshield to retrieve the sun shade. In many modern cars, the windshield has such an extreme and long slope that it is almost impossible to reach down the bottom of the windshield without getting out of the car and reaching down from the side. In addition, if dust collects near the bottom of the windshield, it can hamper the extension mechanism, thus creating problems or malfunctions as the shade is extended.

To this end, it would be desirable to produce and utilize a sun visor, light visor or sun shade and related system, wherein the shade is retractable and extendable from side-to-side, instead of up-to-down or down-to-up. In addition, a desirable shade system would be able to be embedded in the side frame or pillar of a vehicle, wall or support, such that it can easily be pulled from left to right, right to left or side to middle (wherein each half of the shade system is pulled from either the left or the right to the middle of the windshield where it is connected to the other half of the shade) by a driver, passenger, operator or home owner. For example, in a home or apartment that has high or tall windows, it might be useful to have a shade system that extends from side-to-side, as opposed to from top-to-bottom.

### SUMMARY OF THE SUBJECT MATTER

A shade system that is designed to shield at least part of a space from light and be embedded into a stable structure or frame, comprises: a top fixture, a bottom fixture, an attachment component, wherein the attachment component is held in place by the top fixture and the bottom fixture, and a flexible light or sun shield component, wherein the shield component is retractably attached to the attachment component. It should be understood that a contemplated shade system is designed to shield the interior of a car, boat, vehicle or space from sunlight, street light or bright light to a fixture, such as a neon sign.

Methods of securing and using contemplated shade systems are also disclosed.

### BRIEF DESCRIPTION OF THE FIGURES

A contemplated shade system 100 is shown in FIG. 1, wherein the shield component 110 is retractably 120 attached to the attachment component 130, so that the shield component rolls or wraps around the attachment component 130 for storage in the receptacle component 140 and can be rolled out for use. Everything is stored and enclosed in the shade case 150.

Another contemplated shade system 200 is shown in FIG. 2, wherein the shield component 210 is retractably 220 attached to the attachment component 230, so that the shield component is attached or coupled to the attachment component 230 for storage in the receptacle component 240 and can be pulled out for use. Everything is stored and enclosed in the shade case 250. The shield component collapses in a pleated or folded fashion up to the attachment component.

FIG. 3 shows a contemplated embodiment, such as one that is included in FIG. 2—the foldable shield component 310. This embodiment shows a series of clips 315 that allow the shield component 310 to be removably and attachably clipped in and out of the attachment component 330. This clip 315 system is designed to be relatively straightforward for the user to interchange the shield component without or with a minimal of tools and instructions. The shield component 310 in this embodiment also has a handle 340 and attachment fixtures 345, wherein the attachment fixtures are used to secure the shield component 310 in place.

FIG. 4 shows a contemplated embodiment 400 of a vehicle (not shown in full) comprising a windshield 450, a passenger mirror 460, a pillar or interior pillar trim 470 and a SRS airbag 480 built into the front portion 490 of the vehicle. In this embodiment, the shade case 420 is closed, wherein the shade component 410 is fully enclosed.

FIG. 5 shows a contemplated embodiment 500 of a vehicle (not shown in full) comprising a windshield 550, a passenger mirror 560, a pillar or interior pillar trim 570 and a SRS airbag 580 built into the front portion 590 of the vehicle. In this embodiment, the shade case 520 is open, wherein the shade component 510 is exposed, but retracted.

FIG. 6 shows a contemplated embodiment 600 of a vehicle (not shown in full) comprising a windshield 650, a passenger mirror 660, a pillar or interior pillar trim 670 and a SRS airbag 680 built into the front portion 690 of the vehicle. In this embodiment, the shade case 620 is open, wherein the shade component 610 is exposed, and extended along the windshield 650.

The automatic form 700 of a contemplated method is shown in FIGS. 7A-7C. In this Figure, the shield component is not seen in FIG. 7A, as it is stored in the shade case 710 that is located in the interior pillar trim 720 of the front 730 of the vehicle (not shown). FIG. 7B shows the shade case 710 open with the shield component 750 moving out of the shade case 710 and across the windshield 740. FIG. 7C shows the shade case 710 open with the shield component 750 extended out of the shade case 710 and across the windshield (no longer shown).

FIGS. 8A-B and 10A-B show that a contemplated shade case 810 may be clipped 820 into or onto the interior pillar trim 830 by using male-female mateable clips 840. FIG. 8A and 10A shows the shade case 810 as it is being clipped into (8A) or onto (10A) the interior pillar trim 830, and FIG. 8B and 10B shows the shade case 810 as it is fully clipped into (8B) or onto (10B) the interior pillar trim 830.

FIGS. 9A-B and 11A-B shows that a contemplated shade case 910 may be molded, permanently affixed or welded 920 into or onto the interior pillar trim 930 by using any suitable method. FIG. 9A and 11A shows the shade case 910 as it is being affixed to the interior pillar trim 930, and FIG. 9B and 11B shows the shade case 910 as it is fully affixed into (9B) or onto (11B) the interior pillar trim 930.

### DETAILED DESCRIPTION

There are a few traditional sunshade designs in the market these days, most of which look cheap, and thus, cheapen the look of your car. The most traditional sunshade being the portable sunshade, which has wrinkles, usually floats around the back of a car or truck causing it to look messy, and since the traditional sunshade often has a decent amount of wear and tear on it, putting it on the front windshield makes even the most expensive cars look cheap and un-kept.

A sun visor, sun shade or light shade and related system has been developed, wherein the shade is retractable and extendable from side-to-side, instead of up-to-down or down-to-up. In addition, a desirable shade system would be able to be embedded in the side frame or pillar of a vehicle, wall or support, such that it can easily be pulled from left to right, right to left or side to middle (wherein each half of the shade system is pulled from either the left or the right to the middle of the windshield where it is connected to the other half of the shade) by a driver, passenger, operator or home owner.

Contemplated embedded designs allow the car, vehicle or room to maintain its aesthetic appeal, everything is compact and organized and there is no free-floating material required. The embedded sunshade, light shade or shade design doesn't damage the sunshade or light shade because it's protected by the interior and doesn't require constant folding and unfolding and storing in the trunk of the car, where it's often damaged by groceries or other items which are stored in the trunk or back seat as well.

Specifically, a shade system that is designed to shield at least part of a space from sun or light and be embedded into a stable structure or frame, comprises: a top fixture, a bottom fixture, an attachment component, wherein the attachment component is held in place by the top fixture and the bottom fixture, and a flexible light shield component, wherein the shield component is retractably attached to the attachment component. The phrase “retractably attached to” means that the light shield component is physically attached to the attachment component, wherein the light shield component can be pulled away from it or from around it and then retracted back to or wrapped around the attachment component.

It should be understood that a contemplated shade system is designed to shield the interior of a car, boat, vehicle or space from sunlight, street light or bright light to a fixture, such as a neon sign. A contemplated shade system 100 is shown in FIG. 1, wherein the shield component 110 is retractably 120 attached to the attachment component 130, so that the shield component rolls or wraps around the attachment component 130 for storage in the receptacle component 140 and can be rolled out for use. Everything is stored and enclosed in the shade case 150.

Another contemplated shade system 200 is shown in FIG. 2, wherein the shield component 210 is retractably 220 attached to the attachment component 230, so that the shield component is attached or coupled to the attachment component 230 for storage in the receptacle component 240 and can be pulled out for use. Everything is stored and enclosed in the shade case 250.

In this embodiment, the shield component collapses in a pleated fashion up to the attachment component for storage and is pulled away from the attachment component for use. It is contemplated that any of these embodiments may also be automatic, in that the user pushes a button, uses an app or activates a remote feature that automatically engages and retracts the shield component.

Contemplated shield components may be made from or may comprise any suitable material, coating, layered material or combination thereof that allows the shield component to function as a shield for UV rays, sunlight, strong lighting or any other lighting or energy that can heat up a space, damage components in the space, undesired fading, cracking or weathering of materials or a combination thereof. Contemplated and suitable materials may include flexible fabric components, mylar or a foil material bonded with plastic, polyester or another type of polymer-based fabric or material, natural materials and fabrics, layered materials comprising combinations of the same or different materials, or combinations thereof.

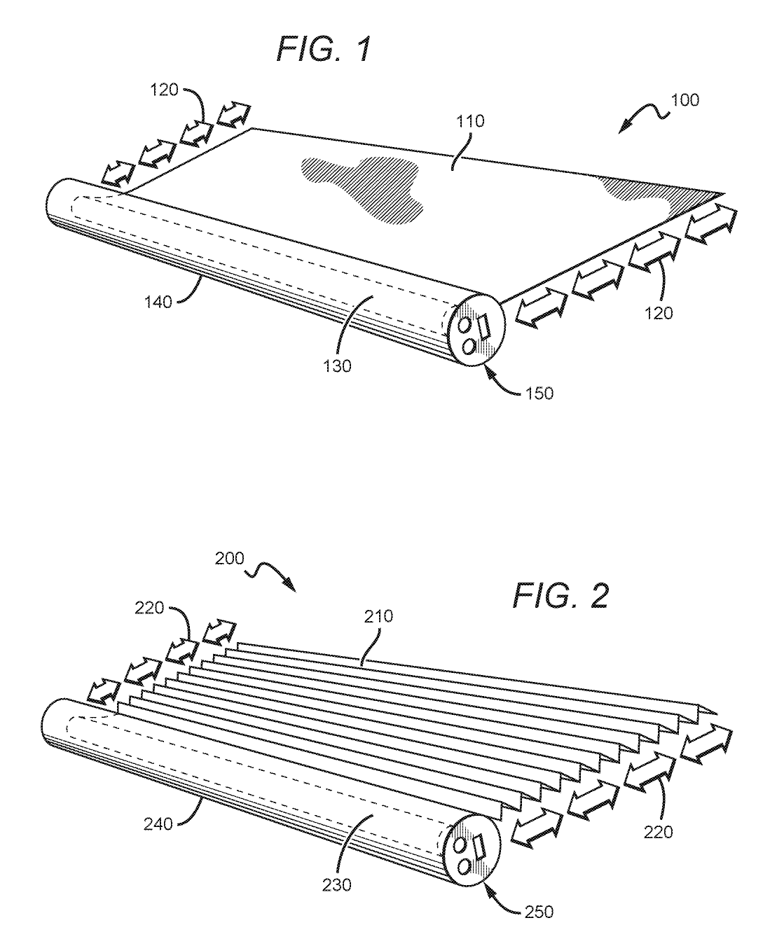

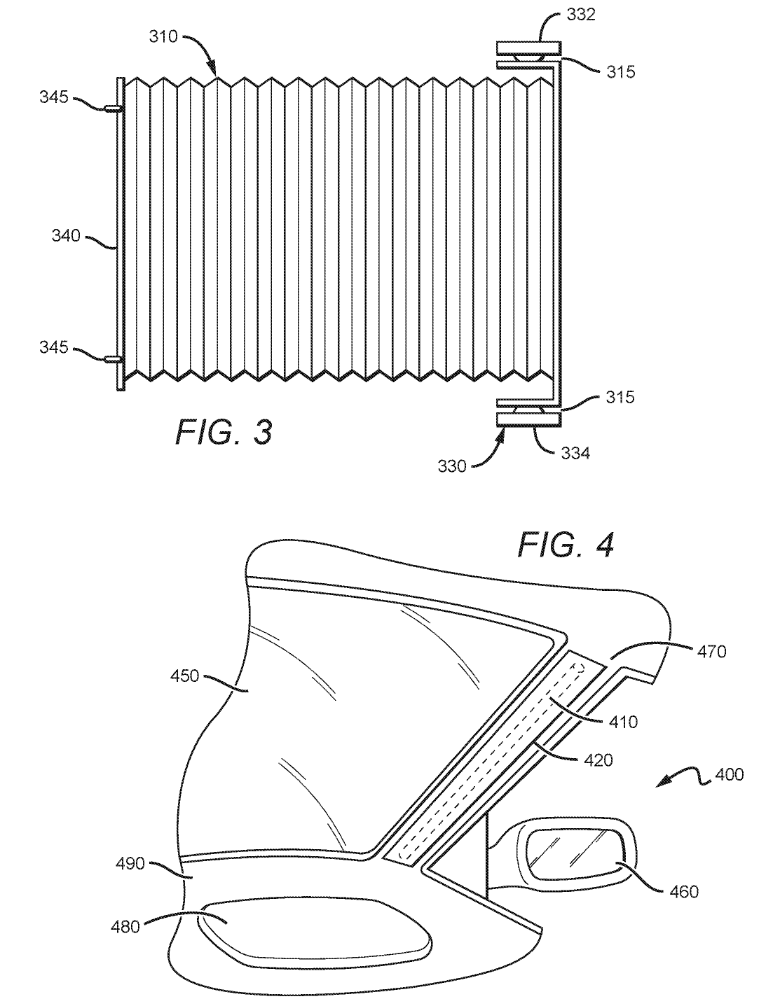

FIG. 3 shows a contemplated embodiment, such as one that is included in FIG. 2—the foldable shield component 310. This embodiment shows a series of clips 315 that allow the shield component 310 to be removably and attachably clipped in and out of the attachment component 330, wherein the attachment component 330 has a top fixture 332 and a bottom fixture 334. This clip 315 system is designed to be relatively straightforward for the user to interchange the shield component without or with a minimal of tools and instructions. The shield component 310 in this embodiment also has a handle 340 and attachment fixtures 345, wherein the attachment fixtures are used to secure the shield component 310 in place.

In some embodiments, the top fixture, the bottom fixture, the attachment component or a combination thereof comprise plastic, metal or a combination thereof. In other embodiments, the attachment component is releasably coupled to the top fixture, the bottom fixture or a combination thereof. In yet other embodiments, the flexible sun or light shield component comprises at least one layer of fabric, composite material, plastic, foil or a combination thereof.

Contemplated shade systems are at least partially encased in a receptacle structure, wherein the receptacle structure is designed to protect the system, enclose the system for storage or a combination thereof. For example, car dealerships may provide a contemplated shade system as an option on a new car. Therefore, they may need to store the shade systems so that they don't get damaged and are also easier to install. So, it is contemplated that shade system is combined with a receptacle structure to form a shade case.

In contemplated embodiments, the shade case is designed to mateably couple with an automobile pillar, a boat frame, a window frame or another fixed, stable structure. As used herein, the phrase “mateably couple” means that one piece or component is designed to fit into the other piece or component in a male-female design. In contemplated embodiments, the automobile pillar, the boat frame, the window frame or the other fixed, stable structure provides the female side of the mateable couple between the shade case and the automobile pillar, the boat frame, the window frame or the other fixed, stable structure.

Methods of using a shade system, as disclosed and contemplated herein, include: providing a shade system, wherein the shade system comprises a top fixture, a bottom fixture, an attachment component, wherein the attachment component is held in place by the top fixture and the bottom fixture, and a flexible sun or light shield component, wherein the shield component is retractably attached to or coupled with the attachment component, providing an automobile pillar, a boat frame, a window frame or another fixed, stable structure, and joining the shade system with the automobile pillar, the boat frame, the window frame or another fixed, stable structure to form a shade assembly. In some embodiments, contemplated methods additionally include installing a cover or covering over the shade assembly, wherein the cover or covering matches or complements the automobile interior, boat interior, window frame or structure. FIG. 4 shows a contemplated embodiment 400 of a vehicle (not shown in full) comprising a windshield 450, a passenger mirror 460, a pillar or interior pillar trim 470 and a SRS airbag 480 built into the front portion 490 of the vehicle. In this embodiment, the shade case 420 is closed, wherein the shade component 410 is fully enclosed.

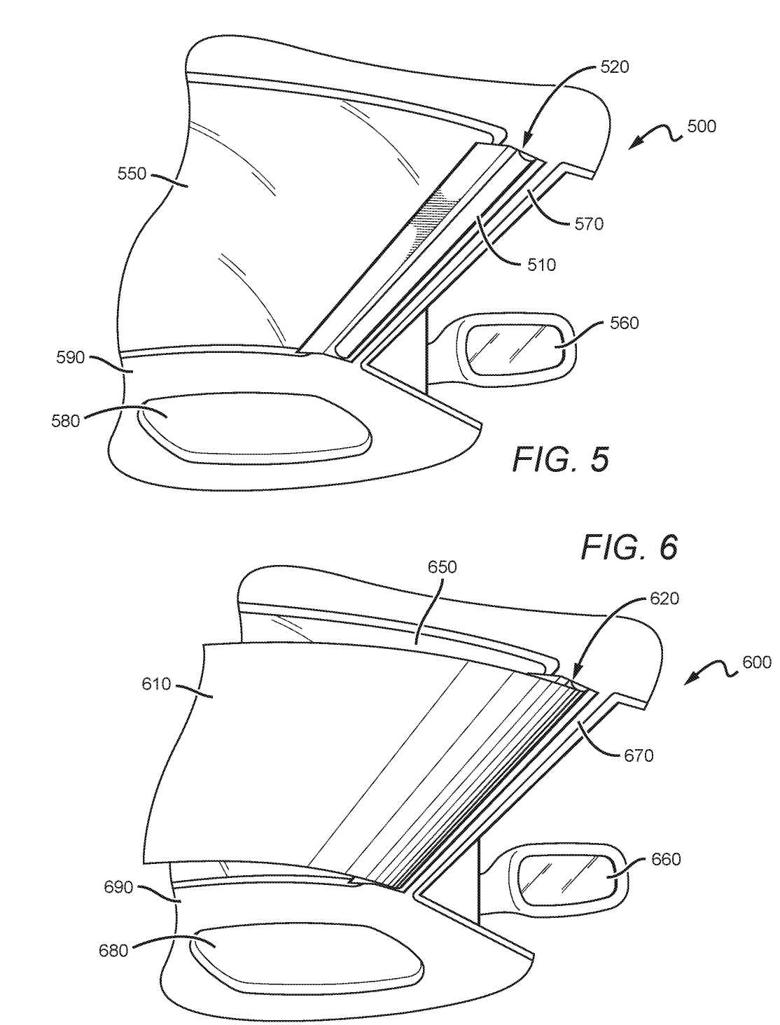

FIG. 5 shows a contemplated embodiment 500 of a vehicle (not shown in full) comprising a windshield 550, a passenger mirror 560, a pillar or interior pillar trim 570 and a SRS airbag 580 built into the front portion 590 of the vehicle. In this embodiment, the shade case 520 is open, wherein the shade component 510 is exposed, but retracted.

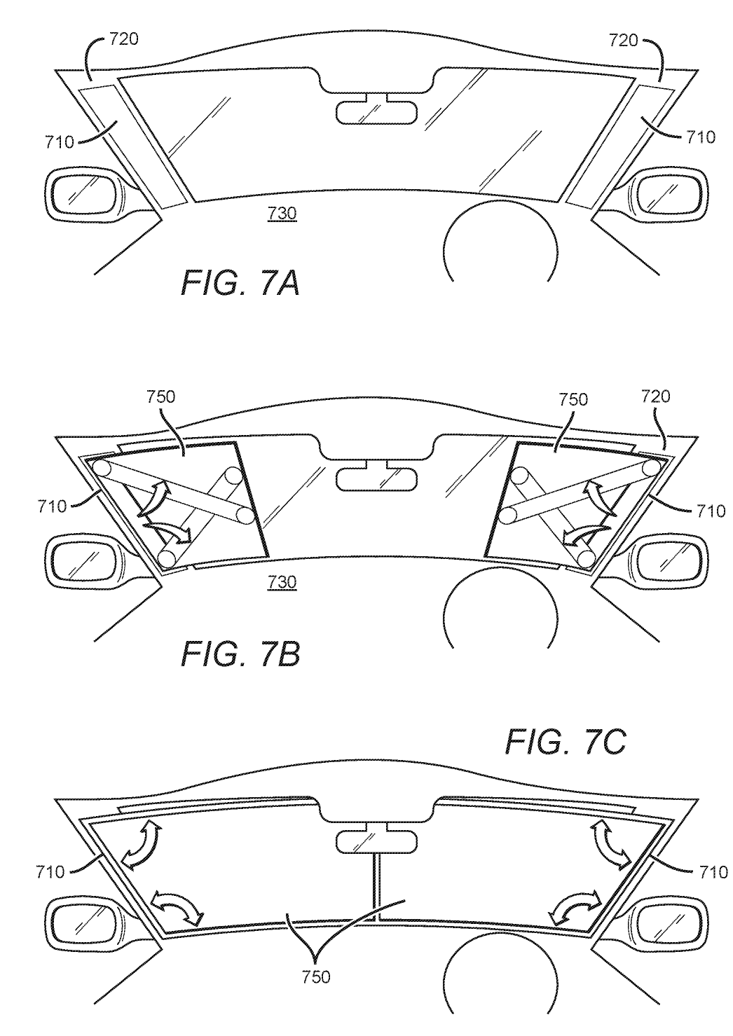

FIG. 6 shows a contemplated embodiment 600 of a vehicle (not shown in full) comprising a windshield 650, a passenger mirror 660, a pillar or interior pillar trim 670 and a SRS airbag 680 built into the front portion 690 of the vehicle. In this embodiment, the shade case 620 is open, wherein the shade component 610 is exposed, and extended along the windshield 650.

Methods of using contemplated shade assemblies are also contemplated that include: providing a shade assembly having a cover or covering, opening the cover or covering, grasping a handle or a portion of the flexible sun or light shield component, sliding the flexible sun or light shield component along the window or windshield from either left to right or right to left, and securing the flexible sun or light shield component, such that it remains in place once the handle or the portion is released. The automatic form 700 of a contemplated method is shown in FIGS. 7A-7C. In this Figure, the shield component is not seen in FIG. 7A, as it is stored in the shade case 710 that is located in the interior pillar trim 720 of the front 730 of the vehicle (not shown). FIG. 7B shows the shade case 710 open with the shield component 750 moving out of the shade case 710 and across the windshield 740. FIG. 7C shows the shade case 710 open with the shield component 750 extended out of the shade case 710 and across the windshield (no longer shown).

Contemplated shade systems and assemblies, as disclosed, are easy to access and use. With the traditional sunshade, you have to usually open the trunk, get out of your car, get the sunshade out of the trunk, put it in place in the front wind shield, and then go about your day. Once you return, you have to complete the retire process again in reverse. This process is annoying, requires a lot of discipline, requires a lot of time, and if the user is in the rush it never gets done, resulting in your car overheating when you return.

On the contrary, with contemplated shade systems and assemblies, the user opens the compartment of the embedded shade located on the passenger side, for example, simply pulls the shade over, and attaches the shade on the driver's side. Once the user returns back to the car, the user simply unhooks the shade, folds it back to the compartment located on the passenger side, and is ready to go. It's easy, organized, and not time consuming.

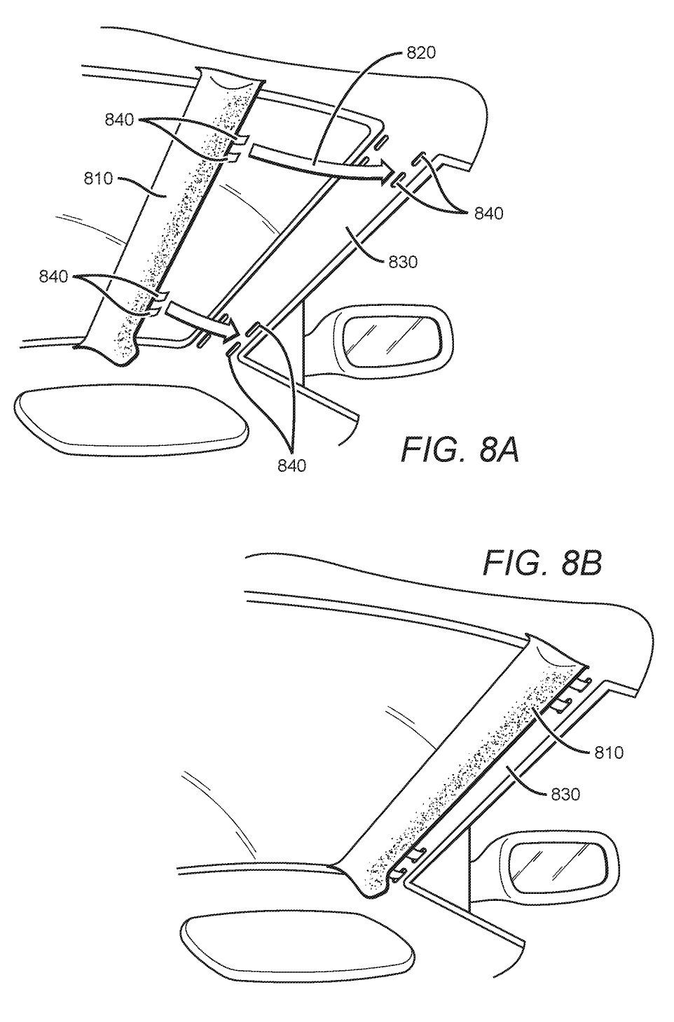

Contemplated shade systems and assemblies are easy to manufacture, easy to install, and don't require the user to be educated on how to use the shade. FIGS. 8A-B and 10A-B show that a contemplated shade case 810 may be clipped 820 into or onto the interior pillar trim 830 by using male-female mateable clips 840. FIG. 8A and 10A shows the shade case 810 as it is being clipped into (8A) or onto (10A) the interior pillar trim 830, and FIG. 8B and 10B shows the shade case 810 as it is fully clipped into (8B) or onto (10B) the interior pillar trim 830.

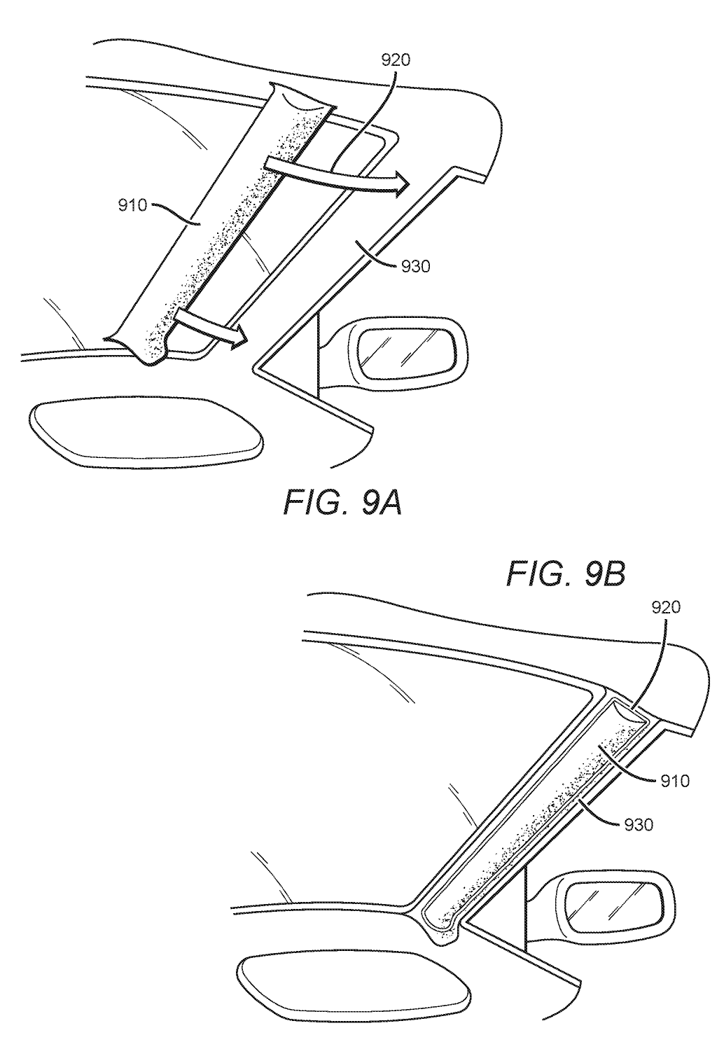

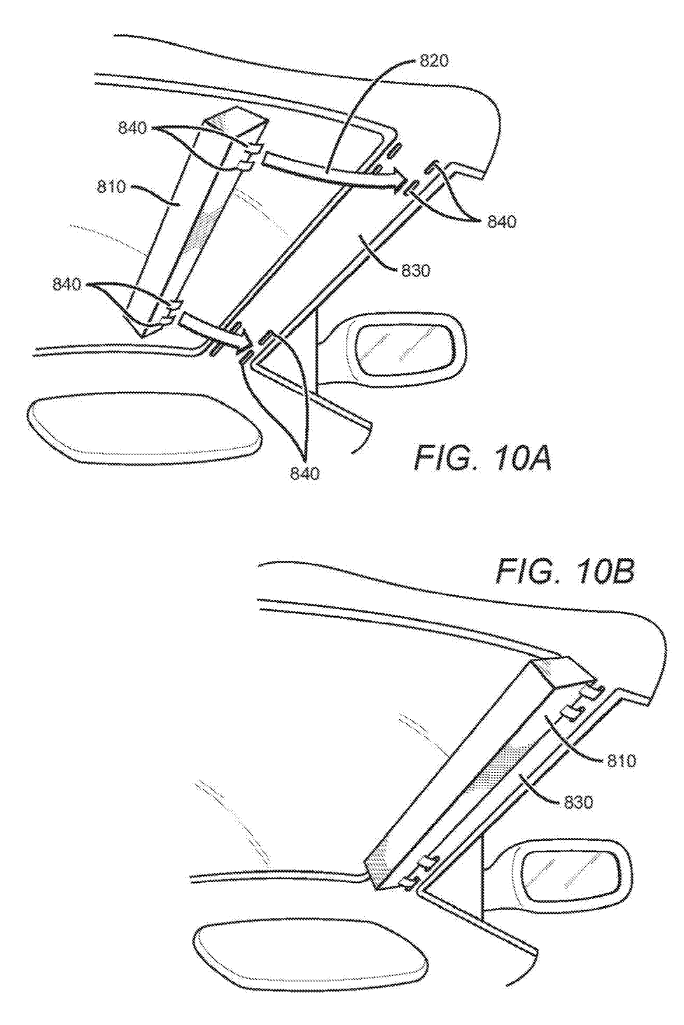

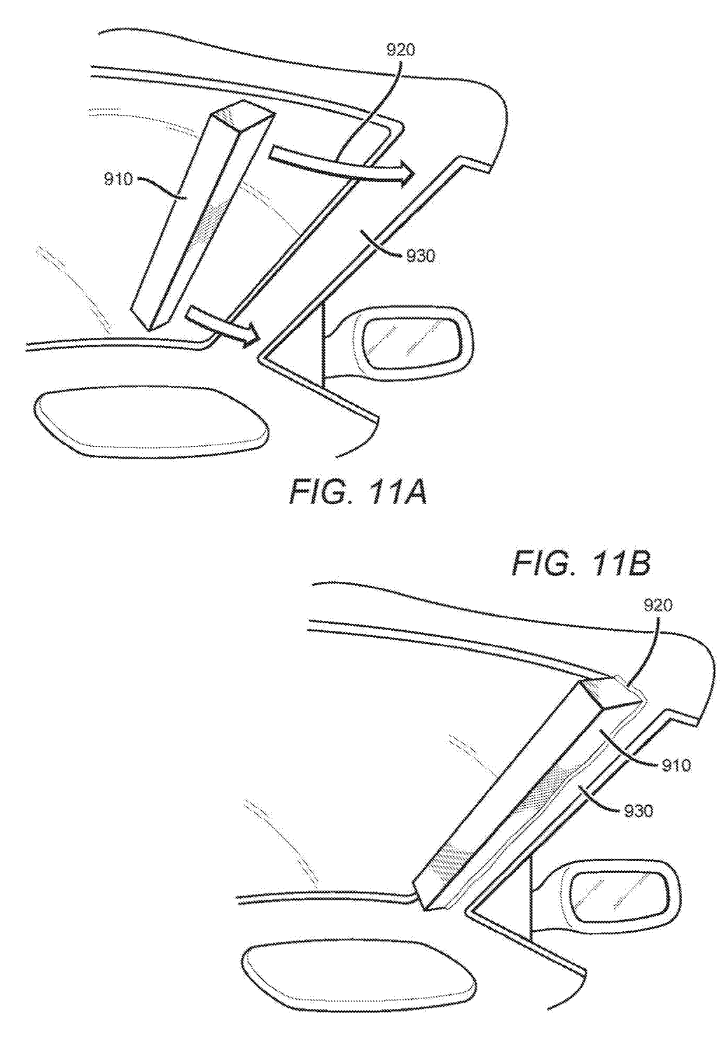

FIGS. 9A-B and 11A-B shows that a contemplated shade case 910 may be molded, permanently affixed or welded 920 into or onto the interior pillar trim 930 by using any suitable method. FIG. 9A and 11A shows the shade case 910 as it is being affixed to the interior pillar trim 930, and FIG. 9B and 11B shows the shade case 910 as it is fully affixed into (9B) or onto (11B) the interior pillar trim 930.

Because of the ease of the installation process and no need for customer education, the price of the car, boat or vehicle will not have a notable increase. Plus, it's very easy to demonstrate the advantage of having an embedded front shield system to potential customers seeking to purchase a new car. This invention is new, is effective, is easy to use, and doesn't ruin the aesthetics of the car. Plus, it solves the age old problem of having to deal with annoying variations of shades.

Thus, specific embodiments, methods of an integrated shade system as a window covering have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1-8. (canceled)

9. A method of using a shade system, comprising:
providing a shade system, wherein the shade system comprises a top fixture, a bottom fixture, an attachment component, wherein the attachment component is held in place by the top fixture and the bottom fixture, and a flexible light or sun shield component, wherein the shield component is retractably attached to the attachment component, and wherein the system is at least partially encased in a receptacle structure, wherein the receptacle structure is designed to protect the system, enclose the system for storage or a combination thereof;
installing a cover or covering over the shade assembly, wherein the cover or covering matches or complements the automobile interior, boat interior, window frame or structure, wherein the shade system, the receptacle structure and the cover or covering form a shade case;
providing an automobile pillar, a boat frame, a window frame or another fixed, stable structure, wherein the automobile pillar comprises an interior pillar trim; and
joining the system case with the interior pillar trim of the automobile pillar, the boat frame, the window frame or another fixed, stable structure to form a shade assembly.

10. The method of claim 9, further comprising:
installing a cover or covering over the shade assembly, wherein the cover or covering matches or complements the automobile interior, boat interior, window frame or structure.

11. (canceled)

12. The method of claim 9, wherein the shade system in combination with a receptacle structure forms a shade case.

13. The method of claim 12, wherein the shade case is designed to mateably couple with an automobile pillar, a boat frame, a window frame or another fixed, stable structure.

14. The method of claim 13, wherein the automobile pillar, the boat frame, the window frame or the other fixed, stable structure provides a female side of the mateable couple between the shade case and the automobile pillar, the boat frame, the window frame or the other fixed, stable structure.

15. The method of claim 9, wherein the top fixture, the bottom fixture, the attachment component or a combination thereof comprise plastic, metal or a combination thereof.

16. The method of claim 9, wherein the attachment component is releasably coupled to the top fixture, the bottom fixture or a combination thereof.

17. The method of claim 9, wherein the flexible sun shield component comprises at least one layer of fabric, composite material, plastic, foil or a combination thereof.

18. A method of using a shade assembly, comprising:
providing a shade assembly having a cover or covering, wherein the assembly is installed on an interior pillar trim of an automobile pillar:
opening the cover or covering,
grasping a handle or a portion of the flexible light or sun shield,
sliding the flexible light or sun shield along the window or windshield from either left to right or right to left, and
securing the flexible light or sun shield, such that it remains in place once the handle or the portion is released.
